(19) United States
(12) Patent Application Publication
(10) Pub. No.: US 2025/0245676 A1
(43) Pub. Date: Jul. 31, 2025

(54) SYSTEM FOR SEGREGATING PURE TONS OF CARBON DIOXIDE EQUIVALENT FROM OTHER ATTRIBUTES EMBEDDED IN EXISTING CARBON CREDITS

(71) Applicants: Alfred Evans, San Pol de Mar (ES); Francois Gigante, Lausanne (CH)

(72) Inventors: Alfred Evans, San Pol de Mar (ES); Francois Gigante, Lausanne (CH)

(21) Appl. No.: 19/036,609

(22) Filed: Jan. 24, 2025

Related U.S. Application Data
(60) Provisional application No. 63/626,107, filed on Jan. 29, 2024.

(51) Int. Cl. G06Q 30/018

(52) U.S. Cl. CPC G06Q 30/018

(57) ABSTRACT

A process for segregating attributes of carbon credits including extracting pure CO2 equivalent from existing carbon credits, tokenizing the extracted pure CO2 equivalent and recording the tokenized pure CO2 equivalent on a distributed ledger. The process includes generating a quality certification mark with an embedded QR code when the tokenized pure CO2 equivalent is used for voluntary offsetting. The embedded QR code provides a link to the distributed ledger for independent verification of offsetting claims. The process includes segregating additional attributes from the existing carbon credits, wherein the additional attributes represent social or environmental benefits associated with carbon projects. The process includes tokenizing the segregated additional attributes and recording the tokenized additional attributes on the distributed ledger or a separate distributed ledger. The distributed ledger is a blockchain wherein the tokenized pure CO2 equivalent is represented as a smart contract on the blockchain.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants make no claim to any trademarks referenced.

### CROSS-REFERENCE TO RELATED APPLICATIONS

This application is a Utility Patent application claiming priority to U.S. Provisional Patent Application Ser. No. 63/626,107, filed on Jan. 29, 2024, which is incorporated by reference herein in its entirety.

### BACKGROUND OF THE INVENTION

### 1) Field of the Invention

The invention relates in general to the field of Carbon Credits, and more particularly, to the growing need to measure and price climate risks that requires a process to create a fungible, commoditized ton of pure CO₂ or CO₂ equivalent to measure and price climate risk with a. market determined price.

### 2) Description of Related Art

The transition to a low carbon economy is accelerating, driven by consumer pressure, regulation, and ecological limits. Putting a price on carbon to reflect the environmental externalities of human activity is an essential part of this transition. The many carbon markets demonstrate wide acceptance of pricing as an important tool to reduce greenhouse gas emissions. More than 80 of these regional regimes cover 25% of global greenhouse gas emissions (GHG), trading in a trillion-dollar market.

Regulations and voluntary commitments increasingly require companies, individuals, governments, and other organizations to purchase Carbon Credits to compensate for the emissions caused by their activities. These commitments are significant: 96% of the world's 250 largest companies have set low carbon targets and financial institutions have committed to push trillions of dollars of global assets toward decarbonization. Businesses and investors exposed to the price of carbon are looking for ways to manage risk and traders are seeking exposure to carbon for commodity linked strategies.

Currently the state of the art includes the creation and use of Carbon Credits. To limit global warming to 1.5 degrees Celsius, in line with the Paris Agreement, society will need to cut current greenhouse-gas-emission levels in half by 2030 and reduce them to “net zero” by 2050. However, there are many activities that cannot be made carbon free. These emissions must be offset by reductions or removals elsewhere to keep total emissions within the global carbon budget. The accounting mechanism to offsetting the carbon emissions of these sectors is Carbon Credits.

Carbon credits currently used for offsetting are created by paying someone else to either reduce their emissions or remove carbon. For example, companies can compensate for their environmental footprint and even, in the most ambitious cases, use Carbon Credits to get to carbon-neutral status.

There are important distinctions between Carbon Credits, Carbon Permits and carbon Project Credits:
a. Carbon Credits are the instruments used to account for use of the atmosphere to dispose of greenhouse gases. Credits are standardized to units of one ton of CO₂ or CO₂ equivalent. There are two primary kinds of carbon credits: Carbon Permits and Project Credits.
b. Carbon Permits are issued by regulatory authorities for use in compliance markets giving the right to emit CO₂ emissions, also known as a carbon allowances. When a company buys or is given a carbon permit, usually from the government, they gain permission to generate one ton of CO₂ emissions. With carbon permits, carbon revenue flows vertically from companies to regulators, though companies who end up with excess credits can sell them to other companies. Companies in regulated markets are free to choose how to best reduce emissions to avoid having to buy permits to meet targets, leading to efficient uses of climate action investments.
c. Carbon Project Credits or Carbon offset projects are verified activities of environmental conservation, energy efficiency or renewable energy which reduce, avoid, or remove greenhouse gas emissions from the atmosphere and contribute to the mitigation of climate change. Projects receive carbon credits to represent the emission reductions achieved, provided the reductions are permanent, additional and precisely measured.

There are two basic types of Climate actions that can earn Project Credits:
a. Those from reduced or avoid emissions (typically energy efficiency measures, capturing methane from animal waste or refraining from cutting down forests)
b. Removed emissions (carbon capture and planting forests)

Companies can meet their climate targets by purchasing carbon credits for their current emissions to achieve net zero emissions from their activities and some commit to going further and using credits to compensate for all their historic emissions.

Other organizations have reduced their emissions as much as possible and used credits to compensate for those they cannot avoid. It is estimated that credits worth 2 billion tons of CO₂ or CO₂ equivalent per year will be needed to get to the 2030 voluntary targets.

Therefore, this growing need to measure and price climate risks for offsetting, investment, trading and risk management requires a process to create a fungible, commoditized ton of pure CO₂ or CO₂ equivalent. Efforts to create such a process repeatedly fail due to the mix of attributes embedded in Carbon Credits created by existing processes. As noted by the Chicago Mercantile Exchange:
a. It is a difficult task to mitigate climate risk without a universal benchmark, which has proven elusive. The uniqueness and regional nature of emissions trading schemes and carbon offset projects have prevented harmonization between programs, and ultimately, the development of a standardized price.

The markets for these credits are fragmented and regionalized and this creates problems with accurately quantifying a credit's environmental value. Therefore, there is a need to harmonize the pricing and sale of Carbon Credits.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a method to address the growing need to measure and price climate risks requires a process to create a fungible, commoditized ton of pure CO₂ or CO₂ equivalent.

The accelerating low carbon transition drives demand for Carbon Credits for many functions, including offsetting, trading, risk management and investment. However, current carbon assets exist in complex, fragmented markets that are inaccessible for nearly everyone and the credits that are accessible a frequently subject to challenge for lack of environmental integrity and outright fraud.

Currently, Carbon Credits are not fungible across these markets due to the wide range of attributes other than CO₂ embedded in every Carbon Credit. Carbon credits from regulated markets are issued with attributes inherently linked to each regional market design. While Project Credits are embedded with the environmental, social, and economic attributes of each of tens of thousands of individual projects. The result is a failure to commoditize in response to market demand for a fungible carbon asset.

The emergence of distributed ledger technology makes possible a process to segregate the various attributes of existing Carbon Credits and deliver a refined, standardized ton of pure CO₂ equivalent available at an independent, market determined price. This commoditized CO₂ removes the barriers preventing financial markets from effectively responding to the needs of the emerging low carbon economy.

The current status is that existing processes create Carbon Credits that are non-fungible, difficult to access and with low environmental credibility. Individual Carbon Credits can be environmentally suspect and scientifically challenging to understand. Buyers of Carbon Credits struggle with the decision as to what carbon asset to purchase in a highly intermediate, inefficient, and mispriced market where every Carbon Credit is different. Even the term “Carbon Credit” lacks a shared meaning.

It is important to understand that “carbon” itself is a misnomer since an individual Carbon Credit can be linked to any of several greenhouse gases (“GHG”). Each GHG has a different warming potential and persistence in the atmosphere. To create a more uniform asset, Carbon Credits use science-based calculations to convert the warming effect of each GHG into equivalent amounts of carbon dioxide expressed as metric tons of C0₂. Thus, Carbon Credits have moved toward commoditization, with measurement standardized at one ton of carbon regardless of the actual gas that is being emitted. However, commoditization has stopped there. There needs to be a process that makes it possible to treat existing multi-attribute Carbon Credits as a raw material where pure commoditized CO₂ can be extracted. In this process, the fragmentation of underlying markets would be a strength by providing diversification and promoting the overarching objective of providing a base price for carbon.

Still other objects and advantages of the invention will in part be obvious and will in part be apparent from the specification.

The above and other objects, which will be apparent to those skilled in the art, are achieved in the present invention which is directed to a method of guaranteeing the value of a Carbon Credit, the method comprising: an algorithm that monitors the number of tons of CO₂ or CO₂ equivalent embedded in the Carbon Credits in a reserve and the number of tons of CO₂ or CO₂ with an decentralized audit process so that equivalent embedded in the Carbon Credits can never be less than the number of minted carbon tokens and unredeemed tokens that are stored in a distributed ledger and the method ensuring that the Carbon token cannot enter the distributed ledger unless it satisfies published standards for environmental credibility at the time it enters the distributed ledger.

One aspect of the invention is directed to a process for segregating attributes of carbon credits. The process includes extracting pure CO₂ equivalent from existing carbon credits, tokenizing the extracted pure CO₂ equivalent and recording the tokenized pure CO₂ equivalent on a distributed ledger. Each token represents one ton of pure CO₂ equivalent interchangeable with any other ton of pure CO₂ equivalent. The process may include generating a quality certification mark with an embedded QR code when the tokenized pure CO₂ equivalent is used for voluntary offsetting. The embedded QR code may provide a link to the distributed ledger for independent verification of offsetting claims. The process may include segregating additional attributes from the existing carbon credits, wherein the additional attributes represent social or environmental benefits associated with carbon projects. The process may include tokenizing the segregated additional attributes and recording the tokenized additional attributes on the distributed ledger or a separate distributed ledger. The additional attributes may include at least one of health improvements, women's empowerment initiatives, biodiversity, employment opportunities, or access to cleaner water. The distributed ledger may be a blockchain wherein the tokenized pure CO₂ equivalent is represented as a smart contract on the blockchain.

Another aspect of the invention is directed to a system for managing carbon credit attributes. The system includes a processor and a memory storing instructions that, when executed by the processor, cause the system to receive carbon credits from multiple sources, extract pure CO₂ equivalent from the received carbon credits, create tokens representing the extracted pure CO₂ equivalent and record the created tokens on a distributed ledger. The instructions may cause the system to generate a quality certification mark with an embedded QR code when the created tokens are used for voluntary offsetting. The embedded QR code may provide a link to the distributed ledger for independent verification of offsetting claims. The instructions may cause the system to segregate additional attributes from the received carbon credits, wherein the additional attributes represent social or environmental benefits associated with carbon projects. The instructions may cause the system to create tokens representing the segregated additional attributes and record the tokens representing the segregated additional attributes on the distributed ledger or a separate distributed ledger. The additional attributes may include at least one of health improvements, women's empowerment initiatives, biodiversity, employment opportunities, or access to cleaner water. The distributed ledger may be a blockchain and wherein the created tokens are represented as smart contracts on the blockchain.

Another aspect of the invention is directed to a method for verifying carbon offsetting claims. The method includes generating a quality certification mark with an embedded QR code when pure CO₂ carbon tokens are used for voluntary offsetting, recording the offsetting transaction on a distributed ledger and linking the recorded transaction to the QR code to enable independent verification of the offsetting claim. The pure CO₂ carbon tokens may be created by extracting pure CO₂ equivalent from existing carbon credits and tokenizing the extracted pure CO₂ equivalent. The pure CO₂ carbon tokens may be recorded on the distributed ledger prior to being used for voluntary offsetting. The quality certification mark may be displayable on products or marketing materials of an entity using the pure CO₂ carbon tokens for offsetting. Scanning the QR code with a mobile device may provide access to the recorded offsetting transaction on the distributed ledger. The distributed ledger may be a blockchain and the recorded offsetting transaction is represented as a smart contract on the blockchain.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a figure showing how carbon assets are compared.

FIG. 2 is a figure showing the current business practice associated with Carbon Credits.

FIG. 3 shows the instant invention business process for Carbon Credits.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term Carbon Credits as used in the specification is meant to mean a Carbon Permit or a Project Credit that has a tradable permit or certificate that represents one ton of carbon dioxide or an equivalent of another greenhouse gas.

The term distributed ledger technology as used in the specification is meant to mean a platform that uses ledgers stored on separate, connected devices in a network to ensure data accuracy and security.

The term CO₂, CO2e or CO₂ equivalent as used in this disclosure is used interchangeably to mean CO₂ equivalent of another greenhouse gas and/or CO₂ equivalent.

The term ESG as used in the specification is meant to mean Environmental, Social, and Governance. ESG factors are used to assess the sustainability of companies and countries. These three factors are seen as best embodying the three major challenges facing corporations and wider society, now encompassing climate change, human rights, and adherence to laws.

Prior to a discussion of the preferred embodiment of the invention, it should be understood that while the features and advantages of the invention are illustrated in terms of a distributed ledger technology many other data structures could be used to with the disclosed process.

To better understand the instant invention, one needs to have a simple introduction to what a Distributed ledger and Distributed Ledger Technology (DLT) is, namely the technological infrastructure and protocols that allow simultaneous access, validation, and record updating across a networked database. DLT is an infrastructure that allows users to view any changes and who made them. A distributed ledger reduces the need to audit data, ensures data is reliable, and only provides access to the distributed ledgers that are maintained by a network of nodes, each of which has a copy of the ledger, validates the information, and helps reach a consensus about its accuracy.

A distributed ledger allows information to be stored securely and accurately using cryptography. The data can be accessed using “keys” and cryptographic signatures. Once the information is stored, it can become an immutable database; the rules of the network, written into the coding of the database programming, govern the ledger.

Because a distributed ledgers are decentralized, private, and encrypted, distributed ledgers are less prone to cybercrime, as all the copies stored across the network need to be attacked simultaneously for the attack to be successful. Additionally, the peer-to-peer sharing and updating of records make the whole process much faster and more effective.

Every device on a distributed ledger network stores a copy of the ledger. These devices are called nodes—a network can have any number of nodes. Any changes to the ledger, such as moving data from one block to another, are recorded across all nodes. Because each node has a copy of the ledger, each one publishes its version with the latest transactions.

If the network reaches a consensus about the validity of the latest ledger, the transactions are finalized, encrypted, and used as a basis for the following transactions.

To begin with, it is important to understand that “carbon” itself is a misnomer, since an individual Carbon Credit can be linked to any of several greenhouse gases (“GHG”). Each GHG has a different warming potential and persistence in the atmosphere. To create a more uniform asset, Carbon Credits use science-based calculations to convert the warming effect of each GHG into equivalent amounts of carbon dioxide expressed as metric tons of C02e. Thus, Carbon Credits have moved toward commoditization, with measurement standardized at one ton of carbon regardless of the actual gas that is being emitted. But commoditization has stopped there.

Existing efforts cannot carry the commoditization process forward due to structural barriers in carbon markets. There are two fundamentally different things that are both considered Carbon Credits: Carbon Permits and carbon Project Credits. Despite both representing one ton of carbon, they are significantly different in form and function, precluding commoditization.

A Carbon Permits providing the owner with permission to emit a ton of CO₂ or CO₂ equivalent are issued by a regulatory agency in one of the regional trading regimes around the world. These permits are necessarily subject to the rules of the local regime. The activities that are regulated vary between markets including power generation, transport, aviation, manufacturing, chemical production, cement, and refining.

As disclosed earlier the problem with Carbon Credits is significant and the transition to a low carbon economy is accelerating, driven by consumer pressure, regulation, and ecological limits. Putting a price on carbon to reflect the environmental externalities of human activity is an essential part of this transition. The many carbon markets demonstrate wide acceptance of pricing as an important tool to reducing greenhouse gas emissions. More than 80 of these regional regimes cover 25% of global greenhouse gas emissions (GHG), trading in a trillion-dollar market.

This higher level of security provided by the instant invention is one aspect that assists the instant invention to achieve the overall goals of creating a system that harmonizes the pricing and sale of Carbon Credits.

With respect to the accounting for Carbon Credits, regulations and voluntary commitments increasingly require companies, individuals, governments, and other organizations to purchase Carbon Credits to compensate for the emissions caused by their activities. These commitments are significant: 96% of the world's 250 largest companies have set low carbon targets and financial institutions have committed to push trillions of dollars of global assets toward decarbonization.

This growing need to measure and price climate risks requires a process to create a fungible, commoditized ton of pure CO₂ or CO₂ equivalent to measure and price climate risk. Efforts to create such a process repeatedly fail due to the mix of attributes embedded in Carbon Credits created by existing processes. The Chicago Mercantile Exchange puts it thus:
a. It is a difficult task to mitigate climate risk without a universal benchmark, which has proven elusive. The uniqueness and regional nature of emissions trading schemes and carbon offset projects have prevented harmonization between programs, and ultimately, the development of a standardized price.

There are a number of structural limitations to the existing carbon marketplace. Existing processes create Carbon Credits that are non-fungible, difficult to access and with low environmental credibility. Individual Carbon Credits can be environmentally suspect and scientifically challenging to understand. Buyers of Carbon Credits struggle with the decision as to what carbon asset to purchase in a highly intermediated, inefficient, and mispriced market where every Carbon Credit is different. Even the term “Carbon Credit” lacks a shared meaning.

Available Carbon Permits represent all the CO₂ or CO₂ equivalent emissions allowed from the regulated sectors of the economy. Actual emissions are measured over a compliance period. At the end of compliance period every company must have one Carbon Permit for every ton of CO₂ or CO₂ equivalent emitted. Depending on market design, Carbon Permits may be given to key industries, sold at auction, or traded with other companies. Some permits can be banked and used in later compliance periods. There are more than 80 kinds of Carbon Permits in regulated markets. Carbon Permits from one market are ineligible for use in other trading regimes.

Conversely, carbon Project Credits are a certification that CO₂ or CO₂ equivalent emissions that would have otherwise contributed to climate change have been voluntarily avoided or removed and sequestered. A Project Credit is issued to a project that avoids emissions or sequesters carbon in a sector or region that is not otherwise subject to carbon regulation therefore defining the term carbon Project Credit. Today, most carbon Project Credits are from sectors such as forestry, renewable energy, and energy efficiency, with small scale efforts to extract CO₂ or CO₂ equivalent from the air for sequestration.

Activities seeking to receive carbon Project Credits must be carried out subject to scientifically based rules that govern measurement, monitoring, and verification of emission reductions. There are more than eight thousand of such projects eligible to issue Carbon Credits. There are hundreds of different types of projects certified by multiple organizations with incompatible standards, each with a separate registry recording issuance of Project Credits. Prices for the resulting carbon Project Credits are determined by buyer preferences for the different environmental, social, and economic attributes of each individual project, rather than the value of a ton of CO₂ or CO₂ equivalent. Carbon Project credits trade over the counter in an unregulated market and are primarily purchased by companies and individuals to cancel or offset their own carbon emissions.

A problem is that the current processes creates Carbon Credits that are not fungible. Carbon credits are not fungible because current Carbon Credits, both Carbon Permits and Project Credits, are composed of many attributes in addition to CO₂ or CO₂ equivalent. To serve as a base price, a carbon asset needs to be a fungible, pure ton of CO₂ or CO₂ equivalent without the limitations imposed by individual market regulators or certification bodies. The essential element of a commodity being lack of differentiation between sources in quality or style, such that users focus primarily on price. A fungible carbon asset would isolate the part of each Carbon Credit's price that is driven solely by the value of carbon from other environmental, social and governance characteristics that influence its price. The base price of CO₂ or CO₂ equivalent should have low correlation to the price of any individual Carbon Credit.

The price for Carbon Permits in regulated markets reflect not only the environmental cost of emitting a ton of carbon but the attributes linked to market design choices and jurisdictional preferences. In unregulated markets, the value of Project Credits is determined by the social, environmental, and economic attributes of the projects that generated the CO₂ or CO₂ equivalent emission reductions. The market says providing cleaner cookstoves in rural Africa is much more valuable than repairing leaky pipelines in Central Asia. The value of the CO₂ or CO₂ equivalent is secondary to other attributes, despite the fact that CO₂ or CO₂ equivalent emissions anywhere in the world have the same environmental impact.

The absence of fungibility means that existing carbon markets cannot provide commodity like multifunctionality. Carbon Credits are demanded for many uses including:
Unregulated companies that voluntarily comply with carbon targets seek an environmentally credible ton of carbon to offset emissions that is scalable, can be simply accessed and is free of reputational risk.
Impact and ESG investors seek ways to invest in carbon at scale for financial and environmental returns from an inflation-adjusting asset that should appreciate during the transition to a low carbon economy
Institutional Investors seek a Carbon Credit to reduce portfolio risk from climate losses but require a market with scale and liquidity
Traders and financial markets want an easily accessible base price to deliver climate finance at scale and to hedge and manage risk via derivative markets
Individuals and environmentally conscious organizations want an easy way to offset the carbon footprint of their activities and have a direct access to the global carbon budget
Multi-jurisdictional organizations need an accessible global reference price for financial risk management and planning

Existing Carbon Credits show how Carbon Credits can be used for these various purposes, but no existing Carbon Credit is sufficiently multifunctional for commoditization. As a result, repeated attempts to establish an international carbon price have failed because of the inherent lack of fungibility between the different kinds of carbon Credits.

To be equitable and transparent, every asset representing an environmentally credible ton of CO₂ or CO₂ equivalent should be of equal value. But lack of fungibility means prices for Carbon Credits are unlinked due to the preponderance of non-carbon attributes in determining value.

A consistent problem with the existing systems is that existing processes do not deliver environmental credibility for most users. A Carbon Credit is only useful if it represents a ton of CO₂ or CO₂ equivalent that will be prevented from contributing to climate change. Many Carbon Credits, particularly Project Credits cannot credibly guarantee climate impacts. The way the system is constructed means Carbon Permits and Project Credits have different environmental concerns.

The environmental integrity of Carbon Permits depends on the design of the market where they are issued. Typically, trading systems go through an evolutionary period where nascent efforts are constrained by what is politically possible and regulatory ambition increases over time as markets mature and market participants become conversant in the regime. Thus, the trajectory of Permit markets is toward increasing credibility.

At the simplest, tradeable Permits accounting for a real cap on emissions in some part of the economy have inherent environmental credibility. Decades of data confirm the effectiveness of well design markets for Carbon Permits in causing real reductions in emissions. Market economics means that prices for Carbon Permits are linked to available supply. Holding them makes prices go up for the remaining permits, thus increasing the price for emitters. Emitters are then free to find the most economical way to achieve compliance, selecting the optimal technology for their operations to efficiently reduce emissions. The result of rising prices is the ceasing of marginal emitting activities that are no longer economic. Users holding permits are denying polluters the right to emit carbon and make activities that do driving emission reductions more expensive. Ultimately, consumers of goods and services decide what activities are desired enough to pay for the climatic environmental externalities of the activity.

Carbon Project Credits face a different set of challenges regarding environmental credibility. Three key concepts inform the environmental credibility of Project Credits: additionality, permanence, and precision of measurement.

The first problem can be described as additionality. Additionality is whether a Project Credit has been awarded for emission reductions that would not have been achieved under business as usual. If a landfill is required by law to capture methane gases, the project should not be given Carbon Credits for those GHG reductions because it is part of business as usual. Sometimes, additionality is an economic question. Most methodologies for renewable energy determine if a project is eligible for Carbon Credits by assessing whether the financial return on the renewable technology makes it competitive as a source of generation. Solar, wind, hydro, and biomass investment costs have fallen over the years such that the additional revenue from Carbon Credits in many markets is no longer required for generators to choose renewable over fossil fuels such as oil, coal, and gas. Thus, these projects are increasingly found to lack additionality and should not be given Carbon Credits.

The assessment of additionality can change over time. Projects that were additional ten years ago may no longer be today. The shifting market preference for different kinds of Project Credits over time reflects these changes as well.

The concept of permanence is key to carbon accounting. A buyer seeking to offset its emissions must be confident that the ton they have purchased has been permanently removed. Forestry and land use methodologies struggle with this aspect of Carbon Credit markets. There are too many examples of forests representing sold Carbon Credits being cut down, dying or burning. Organizations certifying or accepting forestry credits have implemented various strategies, such withholding reserves, to acknowledge the permanence risks of these types of credits.

In the Project Credit market, there are credible questions as to environmental credibility for nearly 70% of the supply. As a result, buyers are no longer willing to buy many of the credits. Forests burn down after issuing Carbon Credits representing sequestered carbon. Instances of outright fraud in project activities are not uncommon, some project methodologies are revised, and project owners engage in undesirable behavior, such as excluding native populations from homelands in the name of protecting forests, creating reputational risk for users of the resulting Project Credits.

Precision in measurement is essential as a prime function of Carbon are to serve as accounting tools. Approved methodologies for carbon projects set out the measurements and data that must be monitored by the project. For some methodologies, such as forestry or soil sequestration, methodologies necessarily rely on sampling of a few points to extrapolate carbon across the project area. The assumptions embedded in these calculations of actual carbon reductions are increasingly questioned as evidence grows of wide divergence between estimations and actual carbon reductions. For users of Carbon Credits, it is important that the source of the Carbon Credit provides a high degree of confidence in the precision of measurement. Otherwise, claims of achieving voluntary carbon reduction targets cannot be verified, undermining collective climate goals, and subjecting the user to reputational damage and financial losses when the shortfalls become evident.

The process and marketplace are further limited because existing markets are difficult to access. For a carbon asset to be useful to the acquiring entity it must be easily acquired, held, and traded. That is not the case. Parties desiring to hold Carbon Credits face a daunting administrative burden such that it is impossible for most investors to hold a diversified portfolio of Carbon Credits. For Carbon Permit markets, holders must establish and maintain a registry account with the relevant regulator. The existing 80 plus markets for Carbon Permits all have separate registries and application requirements requiring administration in multiple geographies and languages. Trading the credits, in turn, requires access to exchanges and financial intermediaries in relevant jurisdictions in multiple currencies. Some markets simply exclude participants that are not regulated entities.

Parties seeking to hold or retire Project Credits need to have registry accounts with the relevant certifying body. Prior to setting up the registry account, the buyer must determine what kind of project they want to purchase Carbon Credits from and source them from the relevant project. There are currently 10+ different certification bodies each with separate processes for creating digital registry entries recording different Project Credits. Setting up a single registry account may be insufficient if a subsequent purchase leads to credits from a different type of project or certifying body.

If one looks at the current issues, there is a need for Commoditization. Commoditization is an important step for carbon markets. To complete the process of commoditization, a ton of carbon needs to be fungible at a commonly recognized base price. If one looks at what occurs with other commodities one can see that a base price is an essential element to unlocking doors to financial markets.

Carbon also has an inherent scale. In addition to outright pricing of emissions of CO₂ or CO₂ equivalent itself that currently covers 11.6 gigatons of carbon, carbon is imbedded in most other commodities from energy and metals to soybeans and corn because of the fuel and carbon-based products need to manufacture, grow, and transport the products to and from the market. In a low carbon economy, trading of these related commodities will implicitly be linked to carbon to manage price risk. Currently, electricity and energy commodities are influenced by the price of carbon in the relevant geography. Corporate decision making relies on pricing carbon for evaluating investments, accounting, and regulatory financial risk disclosures. Asset managers and listed companies are required to disclose climate risk to their businesses.

Due to the absence of a base price for CO₂ or CO₂ equivalent, scaling of markets is hindered, impeding the transition to a low carbon economy. To maximize environmental outcomes, economic models for environmental markets tell us that emission reductions should be done where the cost of mitigating or sequestering a ton of carbon is lowest, so that each dollar spent achieves the greatest environmental benefit. When pricing for a ton of CO₂ or CO₂ equivalent varies widely between different markets, economic actors' decision making is inherently inefficient.

If one examines the emergence of other high-volume commodities, the markets rely on a base price for the physical commodity. Such pricing facilitates access to a robust, global financing system for the commodity industry. The existence of trade financing provides financing for production, storage, and transport of the commodities. Banks rely on the ability to hedge price risk from commodity offtake to reduce the risk associated with lending decisions. Supply chain financing provides working capital efficiency and leverages forward purchase agreements from credit worthy buyers. Financial derivatives permit hedging and risk management. If one could implement a robust financial ecosystem for Carbon Credits, it could fund the transition to a low carbon economy. Therefore, the need to implement a marketplace where CO₂ or CO₂ equivalent is commoditized with a base price will encourage the commoditization of Carbon Credits and finance emission reduction projects.

The instant invention provides the following unique features for the Carbon Credit marketplace:

Registry Technology: Carbon Credit exist in their native form as digital entries in various public and private registries around the world. The process uses a distributed ledger technology not to tokenize off-chain Carbon Credits but to create a ton of CO₂ or CO₂ equivalent that, due to the digital nature of carbon assets, functions as other physical commodities.

Commoditization: The process provides access to a pure ton of CO₂ or CO₂ equivalent with a value that can be determined by independent, market determined global base price. Current efforts to create a tradable base price fail due to fragmentation and structural limitations in accessing multiple independent markets.

Digitization to Segregate Attributes: All current Carbon Credits represent a mix of attributes in addition to CO₂ or CO₂ equivalent determined by the jurisdiction where they are created or the private registry issuing credits to hundreds of kinds of projects. In the process, these attributes are segregated to provide pure CO₂ or CO₂ equivalent for backing a Carbon Credit as well as the possibility to separately value other social attributes of voluntary Carbon Projects, such as health, women's empowerment, employment, or cleaner water.

Tokenization: While there are efforts to use distributed ledger technology to tokenize specific Carbon Credits. These digital tokens represent rights to a specific underlying carbon credit, failing to solve the problems of fungibility, functionality and scale. Rather than tokenizing existing Carbon Credits, the distributed ledger is used to create a new carbon credit whose environmental integrity is secured by a publicly visible, independently verifiable reserve of Carbon Credits.

Democratization: Anyone may be permitted, anywhere in the world with an internet connection to take concrete action on climate. The process provides access Carbon Credits in a simple process without the administrative costs and burdens to hold individual Carbon Credits in many markets and without the need to assess and select between the hundreds of different kinds of Carbon Credits each with a wide range of attributes.

Independent Certification: A QR code certification created when the pure C02 Carbon tokens are used for voluntary offsetting functions. This eliminates allegations of greenwashing against offsetting claims and the many instances of fraud and reputational impacts for buyers. Our use of distributed technology permits the creation of a certification mark with embedded QR coding that permits any stakeholder to independently verify the validity of claims of offsetting with the immutable security of a blockchain distributed ledger.

As noted, the current processes fail to solve the problems associated with commoditization of Carbon Credits. Efforts to commoditize carbon have been made using a variety of financial instruments including pooling Project Credits, exchange traded products, financial derivatives, funds, and tokenized carbon credits. These products demonstrate the consensus around the key characteristics for a carbon commodity: fungibility, standardized specifications and multifunctionality with market-based pricing. Unfortunately, each of these assets address only part of the commoditization challenge, improving access, but failing to complete the commoditization process.

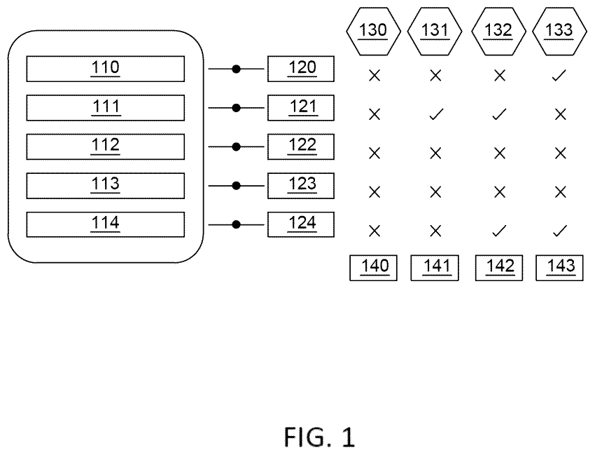

FIG. 1 shows a chart of the current carbon asset comparison process. The commodity criteria is evaluated based on reliably suppling an environmentally credible ton of carbon 110 (credibility) 120; level of intermediation, administrative burdens and cost 111 (Accessibility) 121; suitable for use across voluntary compliance, investment, and trading 112 (Functionality) 122; providing a global price for a ton of carbon from a diversified pool 113 (Fungibility) 123 and sufficient supply in liquid markets to support financial derivatives 114 (Scalability) 124. These criteria can be mapped into the following Project Credits 130, Crypto tokens 131, carbon ETF 132 or Carbon Permits 133. Project Credit 130 types include CER, VER, REDD, and VCS Gold Standard 140. Crypto tokens 131 include Moss, Universal, AitCarcon, Toucan, Klima, JustCarbon, and Flow. 141, 142 and 143. Carbon ETF 132 types include KRBN, KEUA, GRN, KCCA, and KSET. Carbon Permit 133 types include EUA, RGGI, CAR, China, Korea, NZ and Mexico. As shown only the check marks indicate compatibility in the current markets.

Many of the current processes, particularly exchange traded products and commercial notes cannot deliver environmental credibility because these processes rely on financial derivatives of Carbon Permits to create an asset that reflects the price of carbon. These efforts fail at commoditization because financial derivatives cannot provide the environmental impact that is achieved by directly holding actual Carbon Credits. The process of removing Carbon Permits from circulation is a precondition to generating environmental impact. This environmental credibility is an essential element of commoditization as many users of Carbon Credits are motivated by environmental impact.

Other processes seeking to generate a base price for carbon fail because trading rules in individual markets make the resulting assets incompatible with existing processes. Settlement rules in some markets require too much time to be compatible with liquidity rules for exchange products. Some registries prohibit tokenization of individual Carbon Credits. Registries for Carbon Permits do not provide for verifiable offsetting functions. As a result, current processes cannot provide a diverse mix of carbon assets required to achieve portfolio effects and deliver a base price.

Some entities are attempting to find a price signal by holding futures contracts for Carbon Credits to avoid the complexity and illiquidity of Carbon Credits. However, these assets are prevented from providing diversification by the absence of futures markets for many Carbon Credits. More importantly, a future contract may provide exposure to the changing price of CO₂ or CO₂ equivalent, but the nature of a future right means no Carbon Permits are removed from the market. Thus, efforts to improve accessibility in this way have the undesirable consequence of reducing environmental credibility.

Demand for Carbon Credits comes from a wide range of motivations. A fungible carbon asset needs to have wide enough functionality to respond to each of these motivations and the changing needs of Carbon Credit users. Current assets are designed for limited purposes that preclude their flexible use in the market without the possibility to shift between trading, investing, and offsetting needs. For example, a company with a net-zero commitment cannot purchase a ton of CO₂ or CO₂ equivalent that can be used both for offsetting emissions and for providing the base price needed for trading purposes. Without this multifunctionality, risk management is impossible. While some financial products improve access but use a process that precludes environmental credibility, other carbon assets have potential for scale but are not fungible. Thus, while existing products demonstrate the multiple uses of Carbon Credits, fragmentation and limited multifunctionality preclude commoditization.

The instant invention provides a process/method that separates the various attributes of existing Carbon Credits and creates a pure ton of CO₂ or CO₂ equivalent. The emergence of distributed ledger technology combined with the inherently digital nature of Carbon Credits provides the basis for a new process to treat existing Carbon Credits as a raw material that can be refined to provide commoditized CO₂ or CO₂ equivalent free of other attributes. In contrast to efforts to use distributed ledger to provide tokenized access to other commodities, like oil or gold, carbon is uniquely a commodity that is digital in its native state. Tokenization of carbon is not a link to some other asset; with a new process carbon tokens can be the actual commodity itself.

The process of the instant invention makes it possible to treat existing multi-attribute Carbon Credits as a raw material from which pure CO₂ or CO₂ equivalent can be extracted. In this process, the fragmentation of underlying markets becomes a strength by providing diversification and promoting the overarching objective of providing a base price for carbon. While prices of individual Carbon Credits reflect the idiosyncratic market designs of the relevant market, the portfolio effect of a diversified pool of Carbon Permits delivers a price signal closely aligned to the correlated value of the ton of CO₂ or CO₂ equivalent underlying each individual Carbon Credit.

CO₂ or CO₂ equivalent is the ideal commodity for distributed ledger infrastructure as they exist only as digital entries in registries in their native state. The emergence of distributed ledger architecture provides a way to overcome the shortcomings of financial market's current approach to carbon Credits:
a. Trustworthiness: A distributed ledger offers full transparency to publicly verifiable token supply, collateral balances, and on-chain procedures, replacing fragmented, opaque, fraud-prone carbon registries.
b. Accessibility: Distributed ledger technology offers direct access to CO₂ or CO₂ equivalent eliminating intermediaries and gives access to all individuals with an internet connection.
c. Scalability: Pure CO₂ or CO₂ equivalent removes the barriers to scale that result from mixing attributes within individual Carbon Credit, enable integration with other smart contract applications like distributed exchanges and apps.
d. Multifunctional: the process creates an asset that is responsive to a wide range of user needs.

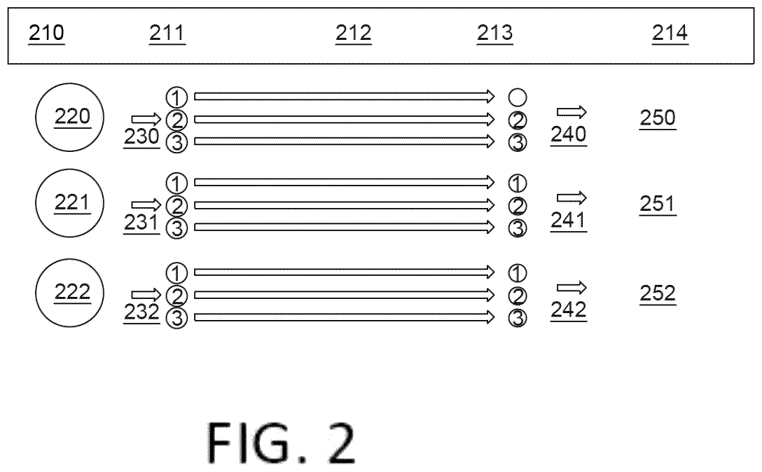

FIG. 2 shows the current business practice. The carbon markets 210 are shown as markets 220, 221 and 222. The Carbon Credits 211 are shown as credits 230, 231 and 232. The Carbon Credits are digitized in step 212 and the digitization results in tokenized Carbon Credit 213 represented by credits 240, 241 and 242. The usefulness 214 can be shown as voluntary offering 250, trading 251 and investment 252.

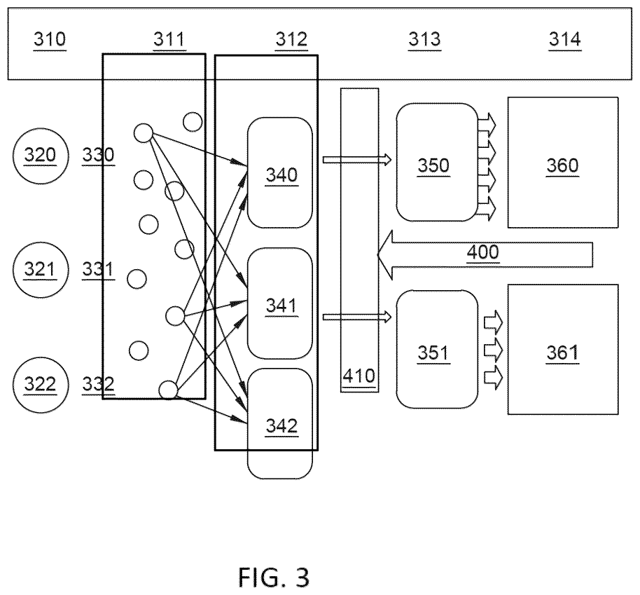

FIG. 3 shows the process of the instant invention. The Carbon Credit origination 310 occurs in the carbon markets represented by 320, 321, and 322. The system does a Carbon Credit aggregation 311 represented by credits 330, 331 and 332, The system then looks at attribute segregation step 312 and creates a CO₂ or CO₂ equivalent bin 340, a social and environmental attributes bin 341 and a residual attributes bin 342. The system then digitizes the credits in step 313 forming Fungible Commodity Token 1Mt CO₂ or CO₂ equivalent 350 and Non-fungible tokens organized by Development Goal 351. The usefulness 314 is shown in item 360 and 361. Item 360 equates to investment asset, trading and derivative portfolio, hedging, and voluntary offsetting. Item 361 equates to Philanthropy, results-based finance, and project finance. The information is then transferred to the distributed ledger using offset Certification 400 and recorded in the distributed ledger item 410. The instant invention then creates a QR code that provides certification of the code that is stored in the distributed ledger. The process includes extracting pure CO₂ equivalent from existing carbon credits, tokenizing the extracted pure CO₂ equivalent and recording the tokenized pure CO₂ equivalent on a distributed ledger. Each token represents one ton of pure CO₂ equivalent interchangeable with any other ton of pure CO₂ equivalent. The process includes generating a quality certification mark with an embedded QR code when the tokenized pure CO₂ equivalent is used for voluntary offsetting. The embedded QR code provides a link to the distributed ledger for independent verification of offsetting claims. The process includes segregating additional attributes from the existing carbon credits, wherein the additional attributes represent social or environmental benefits associated with carbon projects. The process includes tokenizing the segregated additional attributes and recording the tokenized additional attributes on the distributed ledger or a separate distributed ledger. The additional attributes include at least one of health improvements, women's empowerment initiatives, biodiversity, employment opportunities, or access to cleaner water. The distributed ledger is a blockchain wherein the tokenized pure CO₂ equivalent is represented as a smart contract on the blockchain.

Another aspect of the invention is directed to a system for managing carbon credit attributes. The system includes a processor and a memory storing instructions that, when executed by the processor, cause the system to receive carbon credits from multiple sources, extract pure CO₂ equivalent from the received carbon credits, create tokens representing the extracted pure CO₂ equivalent and record the created tokens on a distributed ledger. The instructions causes the system to generate a quality certification mark with an embedded QR code when the created tokens are used for voluntary offsetting. The embedded QR code provides a link to the distributed ledger for independent verification of offsetting claims. The instructions causes the system to segregate additional attributes from the received carbon credits, wherein the additional attributes represent social or environmental benefits associated with carbon projects. The instructions cause the system to create tokens representing the segregated additional attributes and record the tokens representing the segregated additional attributes on the distributed ledger or a separate distributed ledger. The additional attributes may include at least one of health improvements, women's empowerment initiatives, biodiversity, employment opportunities, or access to cleaner water. The distributed ledger is a blockchain and wherein the created tokens are represented as smart contracts on the blockchain.

A method for using the system includes generating a quality certification mark with an embedded QR code when pure CO₂ carbon tokens are used for voluntary offsetting, recording the offsetting transaction on a distributed ledger and linking the recorded transaction to the QR code to enable independent verification of the offsetting claim. The pure CO₂ carbon tokens are created by extracting pure CO₂ equivalent from existing carbon credits and tokenizing the extracted pure CO₂ equivalent. The pure CO₂ carbon tokens are recorded on the distributed ledger prior to being used for voluntary offsetting. The quality certification mark is displayable on products or marketing materials of an entity using the pure CO₂ carbon tokens for offsetting. Scanning the QR code with a mobile device may provide access to the recorded offsetting transaction on the distributed ledger. The distributed ledger may be a blockchain and the recorded offsetting transaction is represented as a smart contract on the blockchain.

the instant invention has the following characteristics:
a. Fixed carbon Value
   i. Each the unit of CO₂ or CO₂ equivalent that the instant invention represents equates to 1 metric ton of pure CO₂ or CO₂ equivalent. Each unit of the instant invention may be fractionalized up to three decimals places (1 Kilogram of CO₂ or CO₂ equivalent) or .001 of the unit of the instant invention.
b. Unlimited supply
   i. the instant invention will have the possibility for unlimited minting, so long as Carbon Credits exist.
c. Guaranteed environmental credibility.
   i. Every Carbon Credit of the instant invention will be irrevocably backed by 1 ton of CO2 from carbon markets selected based on environmentally credibility and availability of independent, market driven prices.
d. Discover of base price
   i. A reasonable approximation of the global value of pure CO₂ or CO₂ equivalent results from this process calculated by correlations between the market value of the Carbon Credits used as raw materials.

Token Engineering means the instant invention can be launched on any distributed ledger that offers compelling benefits. The process relies on smart contracts that follows a standard protocol for representing custom tokens on the blockchain stating basic token characteristics (name, symbol, decimal precision), tracking the number of tokens, tracking a token balance for each address, and permitting users to transfer CO₂ or CO₂ equivalent to other addresses.

The instant invention process provides for three functions whereby CO₂ or CO₂ equivalent can be Minted, Redeemed and Burned.
a. Minting: The instant invention process permits users to request the extraction and delivery to them of pure tons of CO₂ or CO₂ equivalent. No other existing business process provides this use.
b. Burning: Offsetting by burning tokens makes the instant invention function as a voluntary offsetting mechanism. As an offsetting process, the instant invention permits voluntary buyers to retire carbon with high environmental credibility, no price intermediation, and commonly recognized, transparent offsetting credentials. A blockchain record of the tons of carbon in the instant invention Reserve provides the trustworthiness and environmental credibility required by offsetters. Off-setters are issued a QR certification market satisfying the need to have greenwashing-proof, easily verifiable.
claims on progress toward their net zero goals. The instant invention is a superior method to prove that an entity is offsetting carbon used within a market because it is easily accessible, reflects market prices beyond the politics of sovereign carbon markets, and avoids the technical complexity of comparing tons of carbon from competing project types. Users have no reputational risk related to individual projects and can hedge financial risks created by offsetting commitments.
c. Redeeming: The ability to redeem the instant invention creates a process to directly invest in the changing value of global CO₂ or CO₂ equivalent. The instant invention will appreciate as carbon prices do, providing a speculation function for investors, a price risk management tool for owners of carbon assets, and a personal hedge against rising consumer prices driven by increases in carbon values. Basket diversification reduces volatility and provides a price closely aligned with the value of a ton of carbon rather than idiosyncratic aspects of individual carbon asset.
d. Trading: The Minting and Redeeming functions permitting traders to participate in changes in the global value of carbon and provides the ability to list the instant invention for trading on popular crypto currency exchanges.

The instant invention promotes collateralization. Users of the instant invention place trust in the distributer ledger of the instant invention reserve that holds collateral representing at least one ton of carbon for every token. Within the distributed ledger of instant invention system, every token created actually represents at least one ton of carbon. The instant invention process guarantees that 1) the number of tons of CO₂ or CO₂ equivalent embedded in the carbon Credits in the reserve can never be less than the number of Minted and unredeemed tokens held in the distributer ledger of the instant invention and 2) no Carbon Credit can enter the reserve unless it satisfies published standards for environmental credibility at the time it enters the reserve.

All the instant invention Carbon Credits will be held in Registry Accounts maintained by independent entities in regulated markets. The Carbon Credits will be held in the name of or on behalf of the instant invention Platform. The Carbon Credits will be held exclusively for the benefit of the instant invention holders and not for the instant invention Platform.

Holders of the instant invention will be able to view the collateral held in Registry Accounts at any time on the instant invention Platform.

Reporting of Reserve holdings will include account statements authorized by the Registry operator and subject to periodic independent audit according to rules published on the platform.

The instant invention can be further described as a method to create a tradeable asset that represents pure tons of CO₂ or CO₂ equivalent free of other attributes embedded in Carbon Credits: the method uses an algorithm or instructions that makes distributed ledger entries recording separately, the carbon and other attributes extracted from a reserve of Carbon Credits and providing for issuing of tokens reflecting the collective availability of each asset in the reserve while providing users with a unique QR quality certification directly linked to immutable distributed ledger entries of the offsetting activities.

In some embodiments the system or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The invention claimed is:

1. A process for segregating attributes of carbon credits, the process comprising:
extracting pure CO₂ equivalent from existing carbon credits;
tokenizing the extracted pure CO₂ equivalent; and
recording the tokenized pure CO₂ equivalent on a distributed ledger;
wherein each token represents one ton of pure CO₂ equivalent interchangeable with any other ton of pure CO₂ equivalent.

2. The process of claim 1 including generating a quality certification mark with an embedded QR code when the tokenized pure CO₂ equivalent is used for voluntary offsetting.

3. The process of claim 2 wherein the embedded QR code provides a link to the distributed ledger for independent verification of offsetting claims.

4. The process of claim 1 including segregating additional attributes from the existing carbon credits, wherein the additional attributes represent social or environmental benefits associated with carbon projects.

5. The process of claim 4 including tokenizing the segregated additional attributes and recording the tokenized additional attributes on the distributed ledger or a separate distributed ledger.

6. The process of claim 5 wherein the additional attributes include at least one of health improvements, women's empowerment initiatives, biodiversity, employment opportunities, or access to cleaner water.

7. The process of claim 1 wherein the distributed ledger is a blockchain, and wherein the tokenized pure CO₂ equivalent is represented as a smart contract on the blockchain.

8. A system for managing carbon credit attributes, comprising:
a processor; and
a memory storing instructions that, when executed by the processor, cause the system to:
receive carbon credits from multiple sources;
extract pure CO2 equivalent from the received carbon credits;
create tokens representing the extracted pure CO2 equivalent; and
record the created tokens on a distributed ledger.

9. The system of claim 8 wherein the instructions further cause the system to generate a quality certification mark with an embedded QR code when the created tokens are used for voluntary offsetting.

10. The system of claim 9 wherein the embedded QR code provides a link to the distributed ledger for independent verification of offsetting claims.

11. The system of claim 8 wherein the instructions further cause the system to segregate additional attributes from the received carbon credits, wherein the additional attributes represent social or environmental benefits associated with carbon projects.

12. The system of claim 11, wherein the instructions further cause the system to create tokens representing the segregated additional attributes and record the tokens representing the segregated additional attributes on the distributed ledger or a separate distributed ledger.

13. The system of claim 12 wherein the additional attributes include at least one of health improvements, women's empowerment initiatives, biodiversity, employment opportunities, or access to cleaner water.

14. The system of claim 8 wherein the distributed ledger is a blockchain and wherein the created tokens are represented as smart contracts on the blockchain.

15. A method for verifying carbon offsetting claims, the method comprising:
generating a quality certification mark with an embedded QR code when pure CO₂ carbon tokens are used for voluntary offsetting;
recording the offsetting transaction on a distributed ledger; and
linking the recorded transaction to the QR code to enable independent verification of the offsetting claim.

16. The method of claim 15 wherein the pure CO2 carbon tokens are created by extracting pure CO2 equivalent from existing carbon credits and tokenizing the extracted pure CO2 equivalent.

17. The method of claim 16 wherein the pure CO2 carbon tokens are recorded on the distributed ledger prior to being used for voluntary offsetting.

18. The method of claim 15 wherein the quality certification mark is displayable on products or marketing materials of an entity using the pure CO2 carbon tokens for offsetting.

19. The method of claim 18 wherein scanning the QR code with a mobile device provides access to the recorded offsetting transaction on the distributed ledger.

20. The method of claim 19 wherein the distributed ledger is a blockchain and the recorded offsetting transaction is represented as a smart contract on the blockchain.
